(19) United States
(12) Patent Application Publication
(10) Pub. No.: US 2008/0302925 A1
(43) Pub. Date: Dec. 11, 2008

(54) Advanced IV Transfer System

(76) Inventors: John Ruehl, Shelbyville, IN (US); Craig Lingel, Danville, CA (US); Chris Bedel, Greensburg, IN (US)

Correspondence Address: John Walter Ruehl, 5425 North 100 West, Shelbyville, IN, 46176, US

(21) Appl. No.: 11/758,339

(22) Filed: Jun. 5, 2007

(51) Int. Cl. F16M 13/00

(52) U.S. Cl. 248/125.1

(57) ABSTRACT

The present invention illustrates the orderly movement of an IV pole, transfer of an IV pole, device to manipulate said IV pole, method of transporting device to manipulate said IV pole with patient related suspension platforms and management and storage of components to complete said transfer of IV pole to/from patient related suspension platforms.

### BACKGROUND OF THE INVENTION

Physical stress and fatigue to patient and healthcare staff associated with maintaining relationships of mechanical IV (intravenous) pumps, IV fluids, IV fluid carrying lines, later mentioned just as “IV components”, to patient and/or patient related suspension platforms when the patient travels outside of the patient room places an undue financial burden on healthcare cost. This patent and claims provides an effective solution for the hospital staff to manage the physical IV related components when the patient is in the room and when the patient travels outside of the patient room without lifting, remounting, adjusting IV fluids and reorganizing IV lines thus creating a more efficient healthcare environment.

The medical care of patients require, and will continue to require, more frequent trips away from the normal patient room. This medical care is of great urgency for all patients and is greatly complicated for sicker patients. The complication in moving patient-tethered equipment, example: mechanical IV (intravenous) pumps and IV fluids and IV fluid carrying lines creates a demand for orderly component movement in a potentially unknown environment example: hallways, elevators, corridors with unknown services example: electric outlets, compressed gases. These environments often do not have the patient room amenities so there is great need to create a novel invention that will satisfy this demand.

This novel invention is self-contained in that it will supply/carry all necessary components to function when in unknown environment example: hallways, elevators, corridors, etc. and with unknown services example: electric outlets, compressed gases, etc. This novel invention contains sockets, fittings, adaptation to permit function with patient related suspension platforms. This novel invention is ergonomic and intuitive to the user.

### SUMMARY OF THE INVENTION

The present invention illustrates the orderly movement of IV pole, transfer of IV pole, an IV pole's method of attachment to patient related suspension platforms, method and management and storage of components to complete said transfer of IV pole to/from patient related suspension platforms.

The novel components; are an IV pole's method of attachment to patient related suspension platforms, the device to manipulate said IV pole to/from patient related suspension platforms, a method to connect the device to manipulate said IV pole to travel in transport with patient related suspension platforms, the device to manipulate said IV pole to operate as self contained apparatus, the device to manipulate said IV pole articulates utilizing good human-factor design, an accessory to support the IV pole to an architectural structure example: wall, ceiling/floor suspension device. The non-novel component is a common telescoping IV pole. The non-novel IV pole is comprised of a telescoping tubular member. The said tubular member accepts a plurality of clamp-able mechanical IV pump and or pump related devices along length in addition curled hooks at top to secure IV fluids.

The patent and claims herein relate to said IV pole adapted with a plurality of fixed interconnect links along said tubular member also said IV pole adapted with fixed interconnect link near end interconnect via mating links with, but not limited to, hospital patient suspension devices, patient seating devices, patient service supply devices, fixed height independent stand, moveable height independent stand. The said interconnect links mate to inverse in shape sockets, provided with product, to transfer said IV pole with orderly linear motion. This orderly motion is vertical with motion through telescoping sliding members with the lift force exerted by but not limited to a concealed counterbalance spring. This counterbalancing motion is started/stopped with a user operable release knob.

The novel components; an IV pole's method of attachment to patient related suspension platforms. During use the interconnect links are aligned, the user operable release knob is actuated and the device to manipulate said IV pole lowers placing the IV pole and associated attachments onto said interconnect links thus removing the load from the device to manipulate said IV pole to the patient related suspension platform. The process is reversed to remove the load from the patient related suspension platform to the device to manipulate said IV pole. The counterbalancing force from the device to manipulate said IV pole is predetermined and compensation to assist or overcome may be necessary. The said IV Pole is held in place on the device to manipulate said IV pole and the said interconnect links by the earths gravitation pull. Once this is complete the IV pole, the device to manipulate said IV pole and the patient related suspension platforms are ready to travel as an orderly group when the patient travels outside of the patient room

The said interconnect links mate to inverse in shape sockets have a cylindrical shape permitting rotation thus allowing, rotational adjustment of the IV pole by the user. These interconnect links mate to inverse in shape sockets with a non marring/self lubricating material permitting effortless rotation In addition the mating surfaces are further separated by a bushing material creating a rotational brake that self adjusts based on the frictional theory F=Pp were F is the force generated, P is the normal load and p is the coefficient of friction of the bushing material.

The novel component; the device to manipulate said IV pole to/from patient related suspension platforms orderly motion is vertical with motion through telescoping sliding members with the lift force exerted by but not limited to a concealed counterbalance spring. This motion is started/stopped with a user operable release knob. The counterbalancing force from the device to manipulate said IV pole may be predetermined and compensation to assist or overcome may be necessary. The device to manipulate said IV pole to from patient related suspension platforms resides primarily on the floor, suspended by rolling casters and is mobile in nature.

The novel component; the device to manipulate said IV pole to travel in transport with patient related suspension platforms has permitting, bracketry to securely attach onto said patient related suspension platforms. The device to manipulate said IV pole resides primarily on said floor or is lifted by the staff elevating mobile casters from said floor reducing contact resistance and physical floor obstruction.

The novel component; the device to manipulate said IV pole to operate as self contained apparatus provides for storage receptacles for all necessary interconnect links, bracketry, associated attachments to complete the function of the device. This device requires no external energy source, except a user, to function.

The novel component; the device to manipulate said IV pole articulates utilizing good human-factor design with user operable release knob, brake pedal, handles, vertical motion all in proximity and location to conform to ergonomic form.

### BRIEF DESCRIPTION OF THE DRAWINGS

FIG. 1 is an isometric view of the IV pole with interconnect links and associated elements. Also a blowup detail of the self lubricating tapered mating link.

FIG. 2 is a cutaway view of the fixed interconnect links near IV pole end.

FIG. 3 is an isometric view of the device to manipulate the IV pole to/from the patient suspension device with horizontal member inset.

FIG. 4 is an isometric view of the IV Transfer System entire assembly.

FIG. 5 is an isometric view of the IV pole mounted to patient surface.

### DETAILED DESCRIPTION

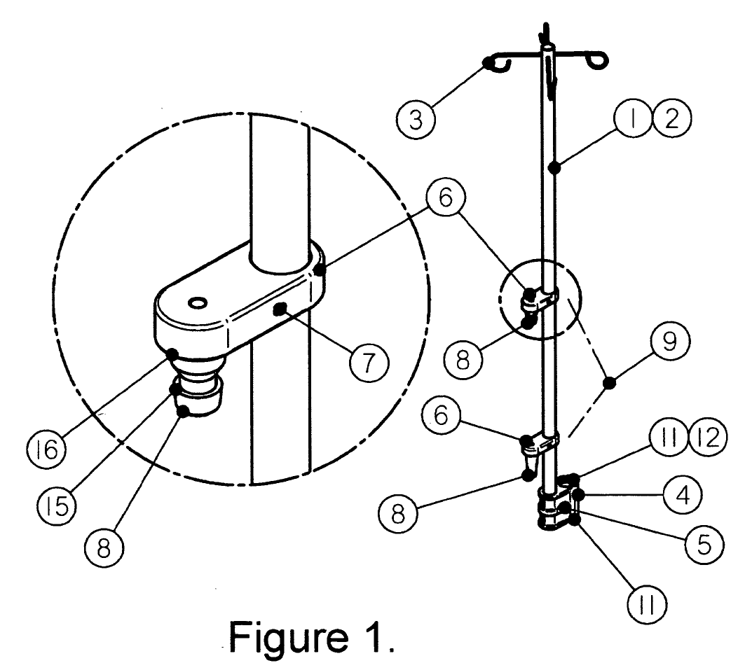

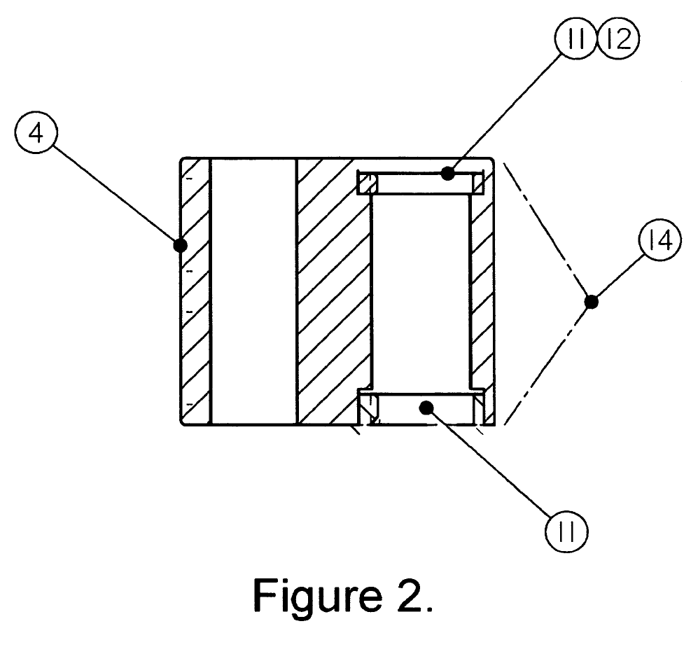

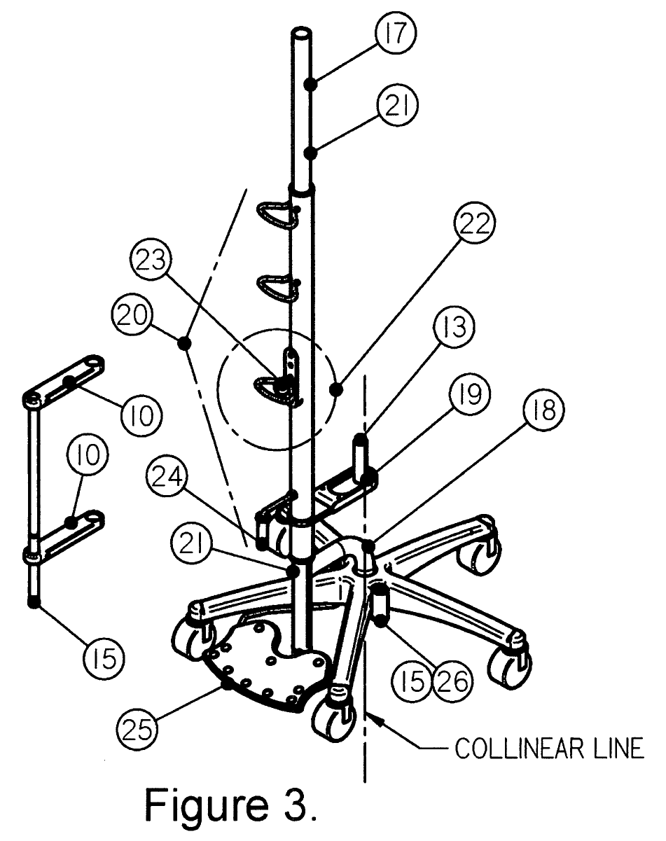

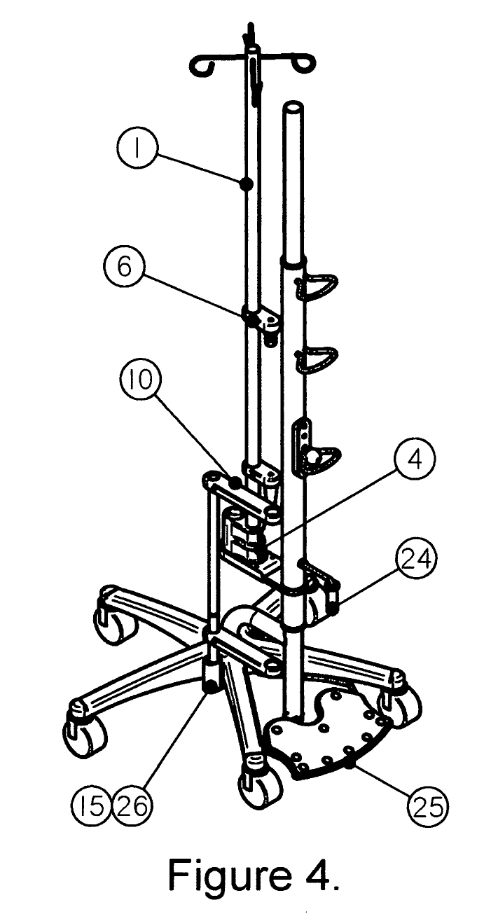

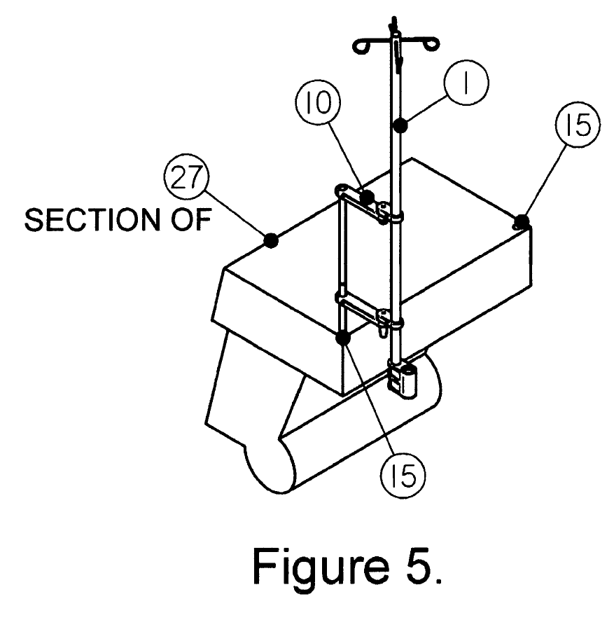

Referring to FIGS. 1 through 5. There is illustrated an IV pole 1 with telescoping tubular member 2 with a plurality of hooks 3. The fixed interconnect links near IV pole end 4 with field adjustment 5, plurality of fixed/moveable interconnect links 6 and varying length tapered mating links 8 are shown some distance from one another 9. These tapered mating links interface to horizontal members 10. The tapered mating links 8 can be grooved 15 also contain a radial ring 16 to resist slip.

The horizontal members 10 as shown insert into socket at 15 to store in addition into socket of patient suspension device 27 and couple the IV pole 1 to patient suspension device 27. Also the independent stand carrying post 24 also inserts into other socket of patient suspension device 27.

Multiple rings Tri-lobe ring(s) 11 and/or disc 12 are secured in fixed interconnect links near IV pole end 4 and tapered mating link 13 are some distance from one another 14.

The independent stands (fixed and moveable height) 17 configured to superimpose the Center of Gravity via member 18. In addition the indexing device 19 at base of tapered mating link 13. The moveable section travels along tubular member 21. The actuator 23 and rotary actuator area 22 are attached to the moveable section Near the floor is the foot pedal 25. Storage sockets 26 are for self contained apparatus aspect of the invention.

The patent and claims herein relate to said Advanced IV Transfer System.

The non-novel IV pole is comprised of a telescoping tubular member with a plurality of hooks to secure IV related fluids. The said tubular member accepts a plurality of clamp-able mechanical IV pump and or pump related devices along length in addition curled hooks at top to secure IV fluids.

The novel claims are as follows:

1) The fixed interconnect link near said IV pole end attaches to said IV pole via an adjustable means for field adjustment or future configuration.

2) The said IV pole adapted with a plurality of fixed/adjustable interconnect links along said tubular member attach via an adjustable means for field adjustment or future configuration.

3) The Tri-lobe (three point contact) disc of self-lubricated material contained in said fixed interconnect link with said tapered mating, link providing support yet minimal friction while inserting both components as means of support. The aforementioned tri-lobe disc with radial disc contained in said fixed interconnect link of appropriate distance as to create lateral support to sturdily support said IV pole.

4) The said tapered mating link also creates collinear insertion and rotational freedom via the self-lubricating material.

5) The said tapered mating can utilize the IV socket on said patient suspension devices, patient seating devices. The said mating link can vary in shape but performs the same function of supporting, the said IV pole.

6) Also, the said tapered mating link can reside on fixed height independent stand and moveable height independent stand.

7) The said fixed/adjustable interconnect links are fitted with a tapered pin of self-lubricating material that fit collinear to respective plurality of horizontal members supported via but not limited to, hospital patient suspension devices, patient seating devices, patient service supply devices, fixed height independent stand, moveable height independent stand. The said tapered pins taper is to more easily locate said interconnect link collinear engagement.

8) The said IV pole adapted with a plurality, of fixed/adjustable interconnect links along said tubular member fitted with said tapered pin of self-lubricating material are of appropriate distance as to create lateral support to sturdily support said IV pole.

9) The said tapered pin of self-lubricating material are sometimes grooved as to allow insertion of additional material to not allow separation from horizontal members.

10) The said tapered pin of self-lubricating material sometimes vary in length as to allow a pre-alignment with horizontal members. Thus eliminating the need to create a plurality visual contact with the said plurality of fixed/adjustable interconnect links along said tubular member.

11) The said tapered pin of self-lubricating material is fitted with a radial ring of slip resistant material engaging between fixed/adjustable interconnect links via said collinear respective interconnect link supported via but not limited to, hospital patient suspension devices, patient seating devices, patient service supply devices, fixed height independent stand, moveable height independent stand. This slip resistant ring creates a radial resistance thus resisting gravitational tendencies.

12) A plurality of horizontal members supported via but not limited to, hospital patient suspension devices, patient seating devices, patient service supply devices create a plurality of horizontal members accepting said tapered pin of self-lubricating material attached to said fixed/adjustable interconnect links said collinearly. The said components are of appropriate distance as to create lateral support to sturdily support said IV pole. Some said horizontal members pivot at base via pivotable hole and bracket thus allowing a radial motion of said IV pole.

13) The said fixed height independent stand and moveable height independent stand tubular member is configured in a non-planer collinear orientation as to superimpose the center of gravity of the said weighted IV pole assembly and said stand more directly in the center of the supporting pattern thus creating a more evenly distributed reactive force.

14) The said fixed height independent stand has a plurality of respective horizontal members supported along its tubular profile via an adjustable means for field adjustment or future configuration.

15) The said fixed height independent stand and moveable height independent stand are fitted with an index device as to prevent unintentional rotation IV pole thus preventing rotational acceleration leading to unexpected forces.

16) The moveable height independent stand supporting said IV pole has said mating link or said tapered mating link that travels relationally on moveable section along tubular member allowing for respective collinear interconnect link varying heights of said fixed/adjustable interconnect links near said plurality of horizontal members as to transfer said IV pole to and from but not limited to, hospital patient suspension devices, patient seating, devices, patient service supply devices.

17) Also, the moveable height independent stand supporting said IV pole has said interconnect links that travels relationally on moveable section along, tubular member allowing for respective collinear interconnect fink varying heights of said fixed/adjustable interconnect links near said IV pole end as to transfer said IV pole to and from but not limited to, hospital patient suspension devices, patient seating devices, patient service supply devices.

18) The moveable height independent stand said travel motion is generated but not limited to a strap fixed on one end and attached to a drum fixed to said moveable section. This drum is rotated but not limited to motor, rotary actuator, mechanical lever. This drum rotation generates tension in the said strap thus causing said motion.

19) The moveable height independent stand said travel motion is generated but not limited to a counterbalanced spring fixed on one end attached to said moveable section creating said relational travel along said tubular member.

20) The said moveable section travel of motion is initiated by but not limited to the clinical user via an ergonomic actuator located near said rotary actuator or related area.

21) The said fixed height independent stand and moveable height independent stand have attachment independent stand carrying post that inserts into but not limited to said IV socket onto but not limited to, hospital patient suspension devices, patient seating devices making this a temporary attachment to said hospital patient suspension devices, patient seating, devices.

22) The said fixed height independent stand and moveable height independent stand has a foot pedal acting as a positioning brake preventing, inadvertent rolling motion.
